(19) United States
(12) Patent Application Publication
(10) Pub. No.: US 2015/0170268 A1
(43) Pub. Date: Jun. 18, 2015

(54) System and Method for Retail Longevity Protection Program

(71) Applicant: Massachusetts Mutual Life Insurance Company, Springfield, MA (US)

(72) Inventor: Stephen David Reddy, Washington Crossing, PA (US)

(73) Assignee: Massachusetts Mutual Life Insurance Company, Springfield, MA (US)

(21) Appl. No.: 14/105,636

(22) Filed: Dec. 13, 2013

(51) Int. Cl. G06Q 40/02

(52) U.S. Cl. CPC G06Q 40/025; G06Q 40/08

(57) ABSTRACT

A system and method for managing a retail longevity protection program. The longevity protection managed by the invention includes a single premium annuity combined with a customized loan program designed to pay the required single premium. The loan is paid down by the annuity benefit payments until fully paid off. The longevity protection program provides a stream of payments throughout the life of the program participant without ceding control of the investments and, thus, the investment risk undertaken by the program participant.

In the preferred form, the longevity protection program takes the form of a fund rider. In this rider, designated a Lifetime Income Fund Enhancement (“LIFE”) Rider, the program participant selects from his or her existing investment accounts, such as a mutual fund, to which account the participant would like to add longevity protection. In this form, a loan, collateralized by the fund assets, is originated to purchase a single premium annuity. The initial annuity payments fund the loan repayment until it is fully repaid, with any subsequent annuity payments accruing to the program participant's mutual fund account. The result is a fund performance that has enhanced returns the longer the participant survives at the expense of diminished fund returns in the event of an earlier death.

### TECHNICAL FIELD

The present invention is in the field of computer-based systems and methods for managing retail longevity protection programs. More particularly, the present invention relates to the management of an annuity that is funded with a loan collateralized by an asset account where the annuity payments and loan payments accrue to the asset account.

### BACKGROUND OF THE INVENTION

The present invention relates to management of longevity risk. Numerous financial processes and products are based on the length of life of a person or group of people. Longevity risk is the risk associated with the life span or life spans associated with such processes or products. From an institutional standpoint, programs and products that make payments for people's lifetime, such as pension funds and annuities, bear significant longevity risk. In addition, individual people bear the longevity risk of outliving their savings.

All financial processes and products are subject to numerous kinds of risk corresponding to the various factors that affect each process or product. Investors in mutual funds bear investment risk of the performance of the stocks in the fund. If the fund invests in foreign stocks priced in foreign currency, the investors are subject to currency risk. There a many other risks based on each factor that influences the performance of the fund. Investors and investment managers must manage each risk associated with the investment process or product.

Investment managers frequently seek to shift certain types of risk to another party in order to concentrate on management of other factors. Thus, the pension fund manager may use vehicles such as currency swaps or longevity swaps to eliminate or reduce these risks. The longevity swap enables the pension fund manager to transfer the longevity risk to another party.

The longevity swap is a derivative contract entered into by a transferor party subject to longevity risk of a group of people, such as a pension fund subject to the longevity risk of group of covered pensioners. This derivative contract is made with a transferee party such as an investment bank or insurer. The transferor party makes regular payments to the transferee party based on agreed mortality assumptions of the covered group. The transferee party then pays out amounts to the transferor party based the actual mortality rates of covered group. Using this tool, the pension fund manager can eliminate the longevity risk and can manage other risks based on the agreed mortality assumptions. The pension fund manager uses tools such as the longevity swap to transfer or hedge longevity risk while retaining other risks such as investment risk, currency risk, inflation risk, etc.

Individual people also have longevity risk associated with the risk that they will outlive their savings. An individual may transfer the longevity risk associated with the individual exceeding the individual's life expectancy to another party through the purchase of a life annuity. When purchasing a life annuity, an individual pays a significant premium in return for a series of payments that continue throughout the life of the individual. One issue with the life annuity is that the individual must transfer a material amount of money, perhaps a significant portion of the individual's life savings, to the insurance company that provides the annuity. In essence, the individual is required to not only transfer the longevity risk, but other risks, including most importantly the investment risk, to the annuity provider as well.

A single premium fixed immediate life annuity pays out level or set increasing payments in return for the payment of initial premium. These payments begin from the time that premium is paid. A single premium fixed deferred life annuity is similar to an immediate annuity except the stream of payments is deferred for a defined period of time. With these products the insurance company takes the single premium and invests the funds in order to provide the payments at the required time. In so doing, the insurance company assumes the investment risk and the longevity risk. Thus, the insurance company benefits from excess investment returns and early death, but suffers from low investment returns and long life. These fixed annuities are beneficial where the individual wishes to transfer both investment risk and longevity risk. Fixed annuities also provide for the individual to transfer the operational burden of making investments and managing the investments over time. The annuity may also provide other regulatory and tax benefits to the annuitant.

Some individuals may desire to transfer longevity risk without transferring the investment risk associated with the transfer of the annuity premium. The insurance industry has developed variable annuities to address this issue. Variable annuities allow the premium payment to be invested in separate accounts or subaccounts with defined investment objectives. However, the premium payment must still be transferred and the investment participation offered by variable annuities often is part of a relatively rigid and expensive package. While variable annuities provide a mechanism for individuals to obtain longevity protection, the mechanism is impractical as a solution for those situations where the individual already owns a significant portfolio of assets and wishes to overlay longevity protection onto such a portfolio. Such a portfolio could not be replicated within a variable annuity at the security level. Only in a very broad manner, by choosing variable annuity accounts or subaccounts that contain similar weightings and exposures to various asset classes to which the individual already has exposure could the individual maintain similar investment exposure via the variable annuity. Further, the process of liquidating the individual's current portfolio could itself be burdensome, expensive and have negative tax consequences.

What is needed is a method and system that allows an individual to transfer the longevity risk that the individual will outlive the individual's savings to a third party, such as an insurance company without the need to incur a large up-front outlay, or to liquidate existing investments that may be needed to fund such large initial outlay, or to alter the individual's investment holdings at any subsequent time in this process.

### SUMMARY OF THE INVENTION

The system and methods of this invention provide for the operation of a longevity protection program (herein referred to as “LPP”) in which an individual, known as the program participant or the LPP participant, may transfer the longevity risk of outliving the individual's savings to a third party such as an insurance company without incurring a large upfront outlay and, thus, without transferring the investment risk associated with such a large upfront outlay. The invention provides for operation of a program that is attractive to current and future retirees looking to monetize accumulated retirement funds.

The LPP of the invention includes a single premium annuity combined with a customized loan program designed to pay the required single premium. The loan is collateralized by an asset account containing the accumulated funds to be used in retirement. The loan is paid down by the annuity benefit payments until fully paid off. If the LPP participant dies with an outstanding loan balance, the loan is paid off with the pledged collateral. The result is a stream of income to the annuitant that extends for the life of the LPP participant with no up-front or out-of-pocket outlay required of the LPP participant.

As there is no up-front outlay to the LPP participant, the LPP participant retains control of the investment risk of the individual's retirement funds. The funds are used to collateralize the loan, but are maintained in the investment vehicle selected by the LPP participant. The LPP thus provides a stream of payments throughout the life of the LPP participant without ceding control of the investment and, thus, the investment risk borne by the LPP participant.

In the preferred form, the LPP takes the form of a fund rider. In this rider designated a Lifetime Income Fund Enhancement (“LIFE”) Rider, the LPP participant selects a mutual fund having desired investment objectives in which to invest retirement savings. The LPP participant then elects to participate in the LPP. A participant may also already hold shares of a mutual fund and simply add the LIFE rider to the account holding those fund shares. In this form, the annuity premium is paid by the loan proceeds. The initial annuity payments fund the loan repayments. The annuity payments and loan repayments accrue to the LPP participant's mutual fund account, with the account being debited with the loan proceeds and interest thereon, and credited with the annuity payments that are used to repay that loan. The result is a fund with performance that has enhanced returns should the participant survive beyond life expectancy coupled with diminished fund returns in the event of an earlier death.

The LPP is a particularly advantageous offering where the funds are managed by the annuity provider or an entity with a close relationship with the annuity provider. In this manner, the annuity provider may provide the loan without significant risk that the funds collateralizing the loan will be mismanaged.

The LPP may thus take the form of a rider to a mutual fund account. In essence, the fund would provide customized margin lending. From the point of view of the fund, the proceeds of this margin lending would be used to purchase an annuity for the benefit of the LPP participant. From the point of view of the annuity provider, the annuity would have a customized investment profile, in that the premium is essentially invested in the collateralized loan. The pricing of the annuity and the loan are thus easily coordinated to reflect their interdependence so that the pricing of the rider primarily hinges on mortality assumptions. The advantages of this combination of margin lending and annuity purchase is that, even although the combination has not heretofore been proposed or marketed, the margin lending and annuity components of the LPP are familiar to regulators and life insurers and have been approved for use and sale in existing markets and jurisdictions.

The result of the LPP is a fund or other portfolio of assets that has enhanced returns due to the annuity payments where the LPP participant outlives his or her life expectancy (i.e., longer than it takes to repay the loan). However, the fund returns are decreased in the event that the LPP participant dies during the repayment of the loan, as the fund assets will be used to pay off the remaining loan balance prior to distribution to the LPP participant's estate at death. In this manner, a LPP participant may transfer longevity risk to another party without ceding investment control of or compromising the investment objectives which guide the management of the participant's retirement savings.

### BRIEF DESCRIPTION OF THE DRAWINGS

FIG. 1 is a diagram of architecture for a typical system for managing the longevity protection program according to the present invention.

FIG. 2 is a flow chart of steps in a typical process for managing the longevity protection program according to the present invention.

FIG. 3 is a chart showing cash flows for an example longevity protection program.

FIG. 4 is a chart showing impact on returns to a longevity protection program participant.

### DETAILED DESCRIPTION OF THE INVENTION

The systems and methods of the invention are directed to the management of a retail longevity protection program, or “LPP”. The systems and method provide for an LPP participant to transfer the longevity risk that the LPP participant will outlive the LPP participant's retirement savings to a third party without a large up-front payment. The LPP includes an annuity that provides income to the LPP participant until the death of the LPP participant. The program further includes a loan used to provide the premium payment required to purchase the annuity. The loan is collateralized by assets of the LPP participant.

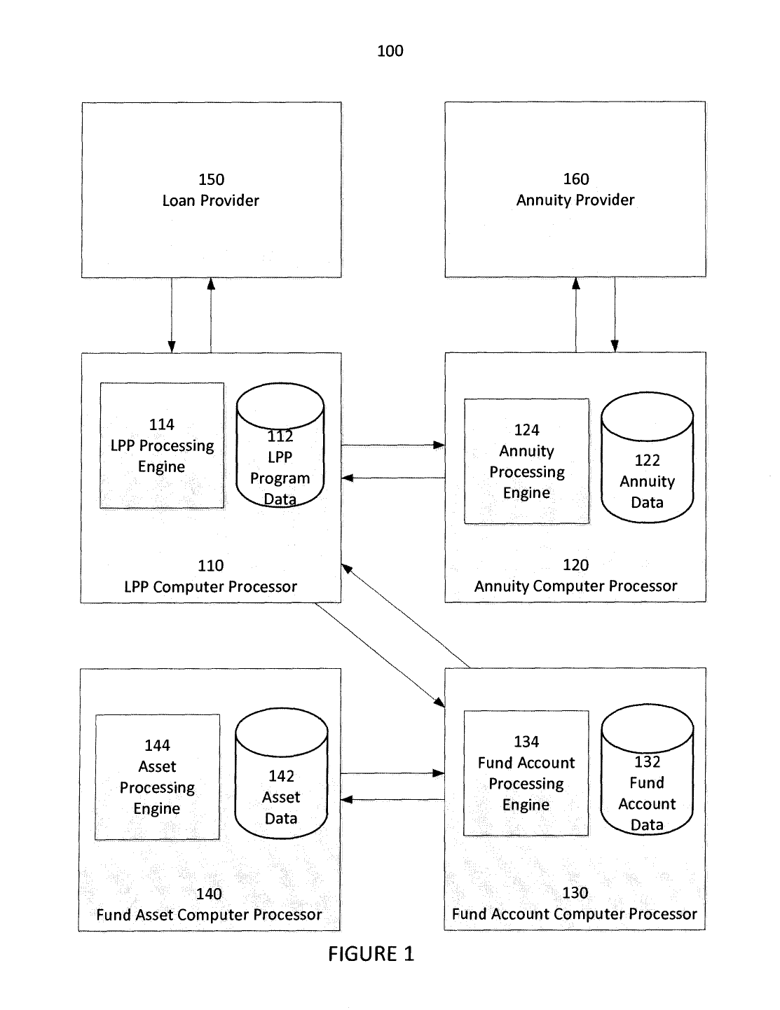

In FIG. 1 is a diagram of computing system architecture 100 for operation of a LPP. The computing system includes one or more computer processors that are programmed to receive and store information regarding the LPP and to provide the LPP participant the benefits of the LPP. Each computer processor access memory in which data necessary for management of the LPP is stored.

LPP computer processor 110 is programmed with an LPP processing engine 114 to manage the unique overall aspects of the LPP. The LPP computer processor 110 accesses memory 112 in which LPP data is stored. The LPP computer processor 110 employs the LPP processing engine 114 to identify assets of the LPP participant to serve as the collateral for the LPP.

In one embodiment, the assets are in the form of shares of a mutual fund held by the LPP participant. The mutual fund account is managed by a fund account computer processor 130. The fund account computer processor is programmed with a fund account processing engine 134 that manages certain aspects of the mutual fund account of the LPP participant. The fund account computer processor 130 accesses memory 132 which stores fund account data. The fund account processing engine 134 performs actions such as tracking shares held, tracking dividends, managing the purchase of and disposition of shares within the account, processing funds received and distributed by the account, and other management activities related to the LPP participant's mutual fund account.

The fund account computer processor 130 communicates with the fund asset computer processor 140. The fund asset computer processor 140 is programmed with an asset processing engine 144 that is used to manage the mutual fund. The fund asset computer processor 140 accesses memory 142 in which asset data is stored regarding the mutual fund. The asset processing engine 144 is used to help manage the mutual fund and provide mutual fund share values to fund account computer processor 130.

The LPP computer processor 110 through the LPP processing engine 114 associates assets of the LPP participant with the LPP of the participant. The LPP computer processor 110 requests and shares data with fund account computer processor 130 in order to determine a loan amount that may be secured by the LPP participant's assets. The longevity processing engine then establishes the parameters of a loan program for the LPP participant in which the loan is collateralized with assets managed by the fund asset computer processor 140 for the participant's account managed by the fund account computer processor 130. The loan is established with a loan provider 150. The loan data is stored in the memory 112. Data regarding the loan is provided to the fund account computer processor 130. The fund account processing engine 134 retains information indicating that the LPP participant's account secures the loan. The fund account processing engine 134 retains and acts on this information in a manner similar to information regarding any margin lending that is secured by the asset accounts managed by the fund account computer processor 130.

Using the loan proceeds, the LPP processing engine 114 communicates through the LPP computer processor 110 with annuity computer processor 120. The annuity computer processor 120 causes an annuity to be purchased from annuity provider 160. The annuity computer processor 120 uses an annuity processing engine 124 that manages the annuity. The annuity computer processor 120 accesses memory 122 in which annuity data are stored. The annuity processing engine 124 determines the parameters of an annuity purchased with the proceeds of the loan. The longevity processing engine 114 causes the annuity processing engine to manage the purchase of an annuity for which the purchase price or premium is funded by the loan proceeds. In particular, the annuity processing engine provides the annuity payment amounts and schedule to the LPP computer processor 110. The annuity processing engine 124 processes each payment to the LPP participant in accordance with the purchased annuity and provides data regarding each annuity payment to the LPP computer processor 110. While the loan remains outstanding the LPP processing engine 114 applies the annuity payments to pay down the loan. The LPP processing engine 114 provides periodic loan balance information, including accrued loan interest, to fund account computer processor 130. Once the loan is repaid in full, the LPP processing engine 114 credits remaining annuity payments to the LPP participant. Typically, the annuity payments are transferred into the LPP participant's account maintained by the fund account computer processor 130. During this stage the LPP computer processor 110 receives information regarding the annuity payments from the annuity computer processor 120 and provides information regarding credits to the LPP participant's asset account to the fund account computer processor 130. This processing continues for the life of the LPP participant enhancing the returns of account maintained by the fund account computer processor 130 for the LPP participant.

In the event that the LPP participant dies prior to complete loan repayment, the outstanding loan balance is repaid with funds obtained from the LPP participant's mutual fund account. In this event, the LPP computer processor 110 receives information regarding the death of the program participant. The LPP processing engine 114 determines the outstanding balance on the loan and provides data to the fund account computer processor 130. The fund account processing engine 134 allocates funds to cover the repayment of the outstanding balance of the loan so that a final distribution from the LPP participant's asset account can be made The executor of the participant's estate might administer the repayment of the loan from the assets in the fund account.

The data stored and exchanged by the computer processors of the invention are based on contracts formed between the LPP participant, the asset fund manager, the loan provider 150, and the annuity provider 160. These contracts are based on data provided by the computer system 100 of the invention. Thus, for example, the computer system 100 may be used to establish an annuity contract between the LPP participant and the annuity provider, funded by a loan which is governed by another contract between LPP participant and loan provider. The annuity, and the distribution of the annuity payments to the LPP participant's asset accounts, and repayment of loans are then managed in accordance with these contracts. In the event, that the asset account is not owned by the LPP participant, but only maintained for the benefit of the LPP participant, the annuity contract may be formed between the fund manager and the annuity provider for the benefit of, and based upon the life of the LPP participant.

The LPP typically utilizes single premium deferred fixed annuities. During the deferral period the interest on the loan is added to the loan balance by the LPP computer processor 110. The loan is then repaid with the annuity payments that begin at the end of the deferral period. Other types of annuities may be used, such as single premium immediate fixed annuities or joint life annuities that extend annuity payments in whole or in part during the lifetime of another life such a as spouse.

In the preferred embodiment, the assets used in the LPP are shares in a mutual fund held in a mutual fund account managed by a broker or mutual fund manager. However, other fund accounts may also be used in the invention. For example, as mentioned above, the LPP participant may have retirement savings in a qualified plan such as a 401(k) plan. In such an instance, as noted above, the plan would purchase the annuity contract. The plan would further pledge its assets to secure the loan, for the benefit of the 401(k) plan participant. Ultimately, the annuity payments would be used by the 401(k) plan to repay the loan, but once repaid, all subsequent annuity payments, along with the other 401(k) assets, would be distributed to the participant.

In the preferred embodiment, the fund manager and the annuity provider are the same entity or closely related entities. In this preferred embodiment, the various computer processors 110, 120, 130 and 140 may be merged into one or more processors that execute the LPP processing engine 114, annuity processing engine 124, fund account processing engine 134, and asset processing engine 144. Similarly, memories 112, 122, 132 and 142 may be merged into one or more memories.

In the merged computer system the asset data is stored in at least one computer memory. At least one computer memory is accessed by at least one computer processor. At least one computer processor executes instructions to associate the assets of the LPP participant with the LPP, to associate a loan to the LPP participant with the associated assets of the LPP participant, to store loan data regarding the associated loan in at least one computer memory, to associate an annuity to the LPP participant with the LPP, and to process periodic annuity payments, including deducting amounts from the annuity payments otherwise due in order to make required loan repayments.

Thus, in the preferred embodiment, an insurance company may provide the annuity and the assets funds or the insurance company may provide mutual funds through an affiliate. In this manner, the LPP may take the form of a rider to the mutual fund. This Lifetime Income Fund Enhancement (“LIFE”) rider attaches to a mutual fund associated with the annuity provider. The computer system 100 provides fund statements to the LPP participant in which the loan payments and annuity payments accrue to the fund returns. The LIFE rider provides features that can enhance the utility and attractiveness of retirement account offerings that are managed in conjunction with annuities issued by an insurance company. In this manner, the LPP participant will see enhanced fund performance where the LPP participant exceeds life expectancy. However, should the LPP participant die prior to the repayment of the loan, the fund proceeds distributed upon death will be reduced. The LIFE Rider thus provides the LPP participant with the opportunity to better match the participant's needs by increasing fund returns in those scenarios in which the LPP participant lives longer and therefore will need greater income in total. Similarly, the LIFE rider would reduce fund returns in those scenarios where the participant dies sooner and needs less income over his or her lifetime.

In operation, the system and methods of the invention serve to reduce the participant's burden of managing a customized loan package and an annuity in addition to an asset account. As noted, above the LIFE Rider may be sold as an addition to an asset account where the purchaser merely realizes enhanced assets account returns upon exceeding the purchaser's life expectancy at the expense of a reduction of the asset account value in the event that the purchaser dies prematurely.

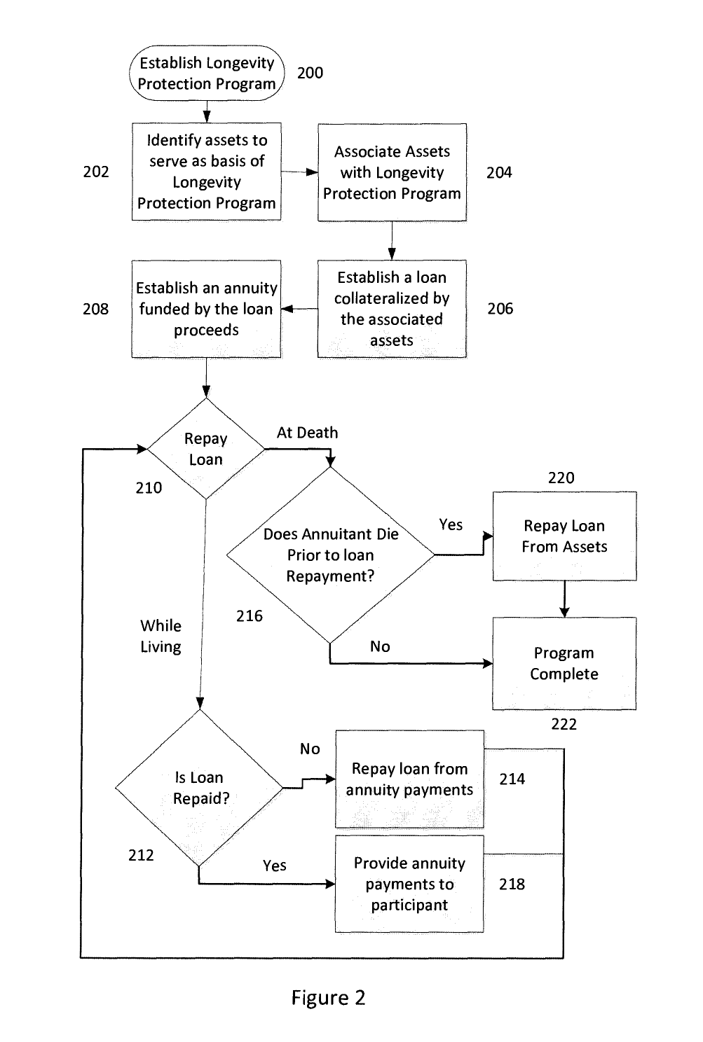

FIG. 2 illustrates a method of the present invention. In the method illustrated by FIG. 2, a computer system as described above is programmed to execute the method of managing an LPP. Initially, an LPP is established for an LPP participant at 200. The program is established in a manner that enhances returns for the LPP participant when the LPP participant exceeds life expectancy without the requirement for a large up-front payment by the LPP participant. In the preferred embodiment, a rider to a managed asset account is established.

At 202, the computer system identifies assets to serve as the basis of the LPP. Typically the assets are assets that are managed for the LPP participant by a fund manager that is affiliated with an annuity provider, such as a mutual fund company associated with an insurance company. However, the assets may be held or for the benefit of the LPP participant in any asset account that provides sufficient security to collateralize a loan.

At 204, the identified assets are associated with the LPP. This association with the LPP serves to limit how the LPP participant may manipulate the assets. For example, while associated with the LPP, the LPP participant may be required to keep assets of sufficient value within an asset account in accordance with the LPP specification.

At 206, a loan collateralized by the associated assets is established. As noted above, the assets are maintained sufficient to fully secure the outstanding loan balance. The loan may be provided by the asset account company, by an insurance company, or by another entity such as a subsidiary of an insurance company set up for such purpose.

At 208, an annuity funded by the loan proceeds is established. As noted above, an insurance company typically issues an annuity contract to the LPP participant. However, the annuity contract may be between the asset account company and the annuity provider for the benefit of the LPP participant. Also, the asset account company and the annuity provider may be a single entity or may be affiliated entities. The annuity is purchased with a premium funded by the proceeds of the loan collateralized by the identified and associated assets. Typically, the annuity is a deferred single premium fixed annuity, but other types of annuities may be employed.

At 212, the loan is repaid with the payments from the annuity. The annuity provides periodic payments for the life of the LPP participant. At 214, the initial annuity payments are applied to pay off the loan balance used purchase the annuity. At 218, in the event that the loan has been fully paid off while the LPP participant is still alive, any subsequent annuity payments will be made to the LPP participant, or the asset account serving to collateralize the participant's loan Typically, the annuity payments are credited to an asset account of the LPP participant that holds the identified and associated assets. The annuity payments, thus, serve to enhance the returns of the asset account when the LPP participant exceeds life expectancy.

At death 216 of the participant, if the LPP participant dies before the loan repayment is complete, then at 220 the loan is repaid from funds derived from the liquidation of identified and associated assets previously pledged to collateralize the loan. Upon the death of the LPP participant, funds derived from liquidation of such assets are used to pay off the loan, thus reducing the value of the remaining assets available for distribution to the LPP participant's estate or to the LPP participant's heirs. The program is completed upon 122—the later of i) the LPP participant's death, and ii) the repayment of the loan.

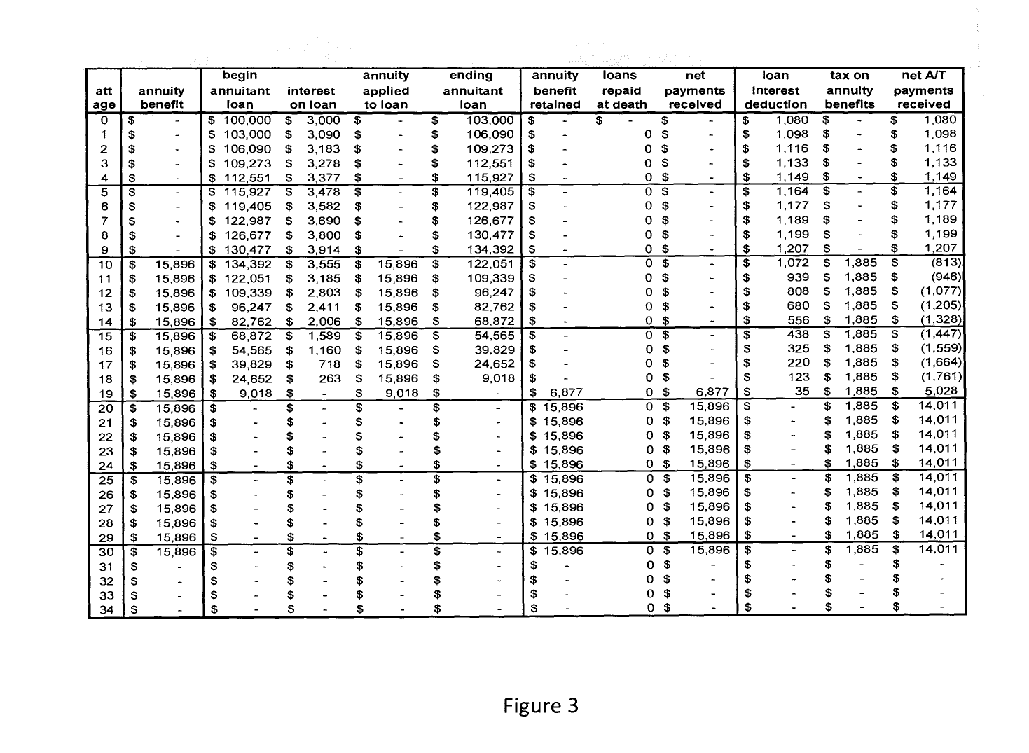

FIG. 3 is a chart showing the cash flows for an example LPP. In this example, the LPP participant has sufficient assents to collateralize a loan for $100,000. The assets may be, for example, mutual fund shares valued at $200,000 held in an associated mutual fund account. The loan-to-value ratio of 0.5 will typically provide sufficient security for the loan as long as the pledged assets are not too volatile. A deferred single premium fixed annuity available for an individual of the age and characteristics of the LPP participant pays $15,896 per year starting 10 years after purchase. Thus the annuity payment is shown in the second column as $15,896 extending from year 10 until the death of the LPP participant.

The cash flows relating to the loan are shown in columns 3-6. The initial loan balance for each year is shown in column 3. The interest that accrues on the loan for the year is shown in column 4. The amount of the annuity payment that is applied to the loan is shown in column 5. The end of year loan balance is shown in column 6. As shown, the loan balance increases due the accrued interest during the deferral period of the annuity in years 1-10. In years 11-19, the loan is repaid with the annuity payments.

The cash flows to the LPP participant are shown in columns 7-9. As shown, after the loan is repaid in year 19, the annuity payments are retained and credited to the account of the LPP participant.

The expexted tax implications of the payments are shown in columns 10-12. Column 10 shows the interest deduction the LPP participant receives. Column 11 shows the taxes due on the annuity payments. Column 12 shows the net after tax payments received by the LPP participant.

As can be seen by the cash flows, the LPP may be structured as a LIFE rider to a fund account in which the assets of the fund account are used to collateralize the loan. This results in no up-front outlay to the LPP participant and permits the LPP participant to retain the investment returns on the investment account. The annuity payments are initially used to pay off the loan. However, once the loan is paid off, the annuity payment are returned to the fund account effectively acting to enhance the returns of the fund account during the remaining lifetime of the LPP participant.

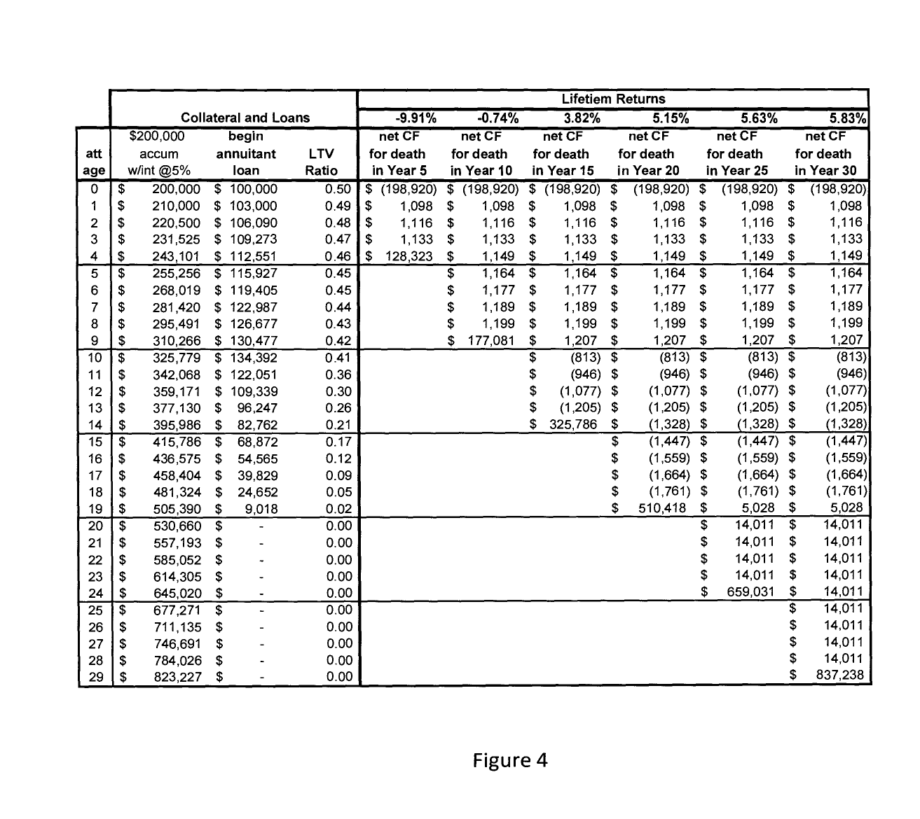

FIG. 4 is a chart showing the impacts on returns to an LPP participant. Columns 2-4 show the value of the asset account, the value of the loan account, and the loan-to-value ratio between the loan account and the asset account. The asset account is assumed to return 5%. The interest on the loan as in FIG. 3 is 3%. The beginning loan value is the same as column 3 of FIG. 3. The loan balance increases in the first 10 years during the deferral period of the annuity and decreases for the next nine years as the annuity payments pay off the loan. The value of the assets account increases through the life of the LPP as investment returns on the full value of the account accrue to the benefit of the LPP participant. In this example, the asset account is assumed to grow at 5% as stated above.

Columns 5-10 show the payments made and received by the LPP participant for each year assuming the participant dies in years 5, 10, 15, 20, 25 and 30 respectively. The loan repayments due upon the premature death of the LPP participant in years 5 and 10 cause the annualized return for the fund with the LPP to be negative for the period during which the LPP was in place. However, the annualized returns for the fund are enhanced when the LPP participant dies in years 20, 25 and 30. As shown, the lifetime return is −9.91% where the LPP participant dies in year 5, −0.74% for death in year 10, 3.82% for death in year 15, 5.15% for death in year 20, 5.63% for death in year 25, and 5.83% for death in year 30. As can be seen, the effect of the LPP is such that the investment returns are enhanced above the assumed 5% return for underlying asset account for the LPP participant who lives longer, at the expense of diminished returns in the case of an earlier death.

It is likely that multiple computing systems or devices will be utilized to implement the method and system in accordance with embodiments of the invention. Each computing system may include a processing unit, a peripheral interface, a user input interface, a system bus, a system memory, a network interface, a memory interface, and any other component. A variety of computer readable media can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM).

The computer processors described above may include basic input/output systems (BIOS) either within the described processing engines or separately. These systems containing the basic routines that help to transfer information between elements, such as during start-up, are typically stored in ROM. RAM typically contains data and/or program modules that are immediately accessible to and/or presently being operated on by processing unit. The data or program modules may include an operating system, receipt management components, other program modules, and program data.

As described above, embodiments of the system of the invention and various processes of embodiments are described. The system of the invention or portions of the system of the invention may be in the form of a “processing machine,” i.e. a tangibly embodied machine, such as specially programmed general purpose computers or special purpose computers. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as any of the processing steps as described herein. Such a set of instructions for performing a particular task may be characterized as a program, software program, or simply software.

As noted above, the processing machine, which may be constituted, for example, by the particular system and/or systems described above, executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize (or be in the form of) any of a wide variety of other technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the Microsoft Windows™ Vista™ operating system, the Microsoft Windows™ XP system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, which enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

While particular embodiments of the invention have been illustrated and described in detail herein, it should be understood that various changes and modifications might be made to the invention without departing from the scope and intent of the invention.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A computer-implement retail longevity protection method for allowing an individual to protect against longevity risk by participating in a longevity protection program in which assets are held in a designated account for the benefit of said individual and said assets are designated as eligible collateral for said longevity protection program, a loan is originated for the benefit of said individual and secured by said assets, an annuity is purchased with the proceeds of said loan for the benefit of said individual, the payments of which annuity are contingent upon said individual remaining alive, said loan is repaid with said payments while said individual remains alive, with the remaining loan balance, if any, of said loan repaid after said individual has died with said assets or liquidation proceeds of said assets, the method comprising:
storing data for said assets, said loan and said annuity in at least one computer memory,
accessing the at least one computer memory with at least one computer processor and executing instructions to perform steps including:
associating data for said assets with data for said loan,
associating data for said loan with data for said annuity,
associating data for said annuity to said account, and
processing periodic annuity payments such that they are credited to the loan balance or asset account of said individual.

2. The method of claim 1, wherein the annuity is a single premium annuity and the loan is made in an amount of the purchase price of the annuity.

3. The method of claim 1, wherein the annuity is single premium fixed deferred annuity.

4. The method of claim 1, wherein the loan is fully paid off after a term and said processing periodic annuity payment includes deducting loan repayments from the annuity payments occurring during the term; said method further comprising:
processing periodic annuity payments after said term has expired.

5. The method of claim 4, wherein the periodic annuity payments are processed during the life of said individual.

6. The method of claim 4, wherein if said individual dies during said term, then processing data regarding pay off of the loan from liquidation of the associated assets.

7. The method of claim 1, further comprising the at least one computer processor executing instruction to process returns of the asset account, the returns taking into account the periodic annuity payments and loan payments and to output said returns.

8. The method of claim 1, wherein the longevity protection program is presented, marketed or implemented as a rider to the designated asset account.

9. The method of claim 1, wherein another account of said individual may be substituted for the currently designated account, and other assets within currently designated account may be substituted as eligible collateral for the currently designated assets during the period of said longevity protection program.

10. The method of claim 9 wherein the expected liquidation value of said currently designated assets is required to exceed said remaining loan balance at all times during the period of said longevity protection program.

11. A computer-implement retail longevity protection management system for allowing an individual to protect against longevity risk by participating in a longevity protection program in which assets are held in an account for the benefit of said individual and said assets are designated as eligible collateral for said longevity protection program, a loan is originated for the benefit of said individual and secured by said assets, an annuity is purchased with the proceeds of said loan for the benefit of said individual, the payments of which annuity are contingent upon said individual remaining alive, said loan is repaid with said payments while said individual remains alive, with the remaining loan balance, if any, of said loan repaid after said individual has died with said assets or liquidation proceeds of said assets, the system comprising:
at least one computer memory storing data for said assets, said loan and said annuity;
at least one computer processor accessing the at least one computer memory and executing instructions to perform steps including:
associating data for said assets with data for said loan,
associating data for said loan with data for said annuity,
associating data for said annuity to said account, and
processing periodic annuity payments such that they are credited to the loan balance or asset account of said individual.

12. The system of claim 11, wherein the annuity is a single premium annuity and the loan is made in an amount of the purchase price of the annuity.

13. The system of claim 11, wherein the annuity is single premium fixed deferred annuity.

14. The system of claim 11, wherein the loan is fully paid off after a term and said processing periodic annuity payment includes deducting loan repayments from the annuity payments occurring during the term; said at least one computer processor further executing a step of:
processing periodic annuity payments after said term has expired.

15. The system of claim 14, wherein the periodic annuity payments are processed during the life of at said individual.

16. The system of claim 14, wherein if said individual dies during said term, then processing data regarding pay off of the loan from liquidation of the associated assets.

17. The system of claim 11, further comprising the at least one computer processor executing instruction to process returns of the asset account, the returns taking into account the periodic annuity payments and loan payments.

18. The system of claim 17, wherein the longevity protection program is presented, marketed, or implemented as a rider to the designated asset account.

19. The method of claim 11, wherein another account of said individual may be substituted for the currently designated account, and other assets within currently designated account may be substituted as eligible collateral for the currently designated assets during the period of said longevity protection program.

20. The method of claim 19 wherein the expected liquidation value of said currently designated assets is required to exceed said remaining loan balance at all times during the period of said longevity protection program.
